(19) United States
(12) Patent Application Publication
(10) Pub. No.: US 2025/0374843 A1
(43) Pub. Date: Dec. 11, 2025

(54) SWEEP ASSEMBLY FOR AN AGRICULTURAL TILLAGE IMPLEMENT

(71) Applicant: CNH Industrial America LLC, New Holland, PA (US)

(72) Inventor: Michael George Kovach, Morton, IL (US)

(21) Appl. No.: 18/738,699

(22) Filed: Jun. 10, 2024

(51) Int. Cl. A01B 15/02; A01B 35/26

(52) U.S. Cl. CPC A01B 15/025; A01B 35/26

(57) ABSTRACT

A sweep assembly for an agricultural tillage implement includes a sweep having a blade and a neck extending from the blade. The neck has a cavity configured to receive an adapter, the cavity is formed in part by a forward left contact surface, a forward right contact surface, a rearward left contact surface, and a rearward right contact surface, and the neck slopes laterally inwardly along a first direction extending from a top opening of the neck toward the blade. Furthermore, a left contact surface angle between the forward left contact surface and the rearward left contact surface is less than or equal to 60 degrees. In addition, a right contact surface angle between the forward right contact surface and the rearward right contact surface is less than or equal to 60 degrees.

### BACKGROUND

The present disclosure relates generally to a sweep assembly for an agricultural tillage implement.

Certain agricultural implements include ground engaging tools configured to interact with soil. For example, certain tillage implements may include sweep assemblies configured to break up the soil for subsequent planting or seeding operations. Each sweep assembly may include a sweep having a blade and a neck. The blade is configured to break up the soil, and the neck is configured to couple the sweep to a shank. For example, an adapter of the sweep assembly may be coupled to the shank by a fastener connection, and the adapter may be disposed within a cavity of the neck. Friction between the adapter and the neck may secure the sweep to the shank, thereby enabling the shank to drive the sweep through the soil during tillage operations. Unfortunately, due to the configuration of the neck and the adapter of certain sweep assemblies, the sweep may disengage the shank during the tillage operation if insufficient force is applied to the sweep when coupling the sweep to the adapter. As a result, the effectiveness of the tillage implement may be reduced, and replacing the sweep in the field may delay the tillage operation.

### BRIEF DESCRIPTION

In certain embodiments, a sweep assembly for an agricultural tillage implement includes a sweep having a blade and a neck extending from the blade. The neck has a cavity configured to receive an adapter, the cavity is formed in part by a forward left contact surface, a forward right contact surface, a rearward left contact surface, and a rearward right contact surface, and the neck slopes laterally inwardly along a first direction extending from a top opening of the neck toward the blade. Furthermore, a left contact surface angle between the forward left contact surface and the rearward left contact surface is less than or equal to 60 degrees, and the forward left contact surface and the rearward left contact surface are configured to engage a left angular protrusion of the adapter. In addition, a right contact surface angle between the forward right contact surface and the rearward right contact surface is less than or equal to 60 degrees, and the forward right contact surface and the rearward right contact surface are configured to engage a right angular protrusion of the adapter.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a top view of an embodiment of an agricultural tillage implement having multiple sweep assemblies;

FIG. 2 is a front perspective view of an embodiment of a sweep assembly that may be employed within the agricultural tillage implement of FIG. 1;

FIG. 3 is a rear perspective view of the sweep assembly of FIG. 2;

FIG. 4 is a top view of the sweep assembly of FIG. 2;

FIG. 5 is an exploded view of the sweep assembly of FIG. 2;

FIG. 6 is an exploded view of a portion of the sweep assembly of FIG. 2;

FIG. 7 is a cross-sectional view of the sweep assembly of FIG. 2; and

FIG. 8 is a side view of an embodiment of a tool that may be employed within the sweep assembly of FIG. 2.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

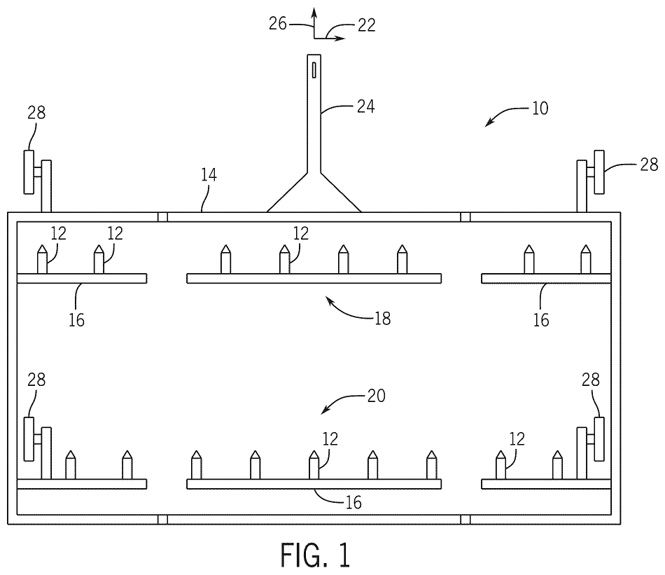

FIG. 1 is a top view of an embodiment of an agricultural tillage implement 10 having multiple sweep assemblies 12. In the illustrated embodiment, the agricultural tillage implement 10 includes a frame 14, and multiple toolbars 16 are coupled to the frame 14. Each toolbar 16 is configured to support one or more sweep assemblies 12. In the illustrated embodiment, the toolbars 16 are arranged in a front row 18 and a rear row 20. However, in other embodiments, the toolbars may be arranged in any suitable configuration (e.g., a configuration having three or more rows, in a staggered configuration, etc.). Furthermore, the sweep assemblies 12 are spaced apart from one another with respect to a lateral axis 22 of the agricultural tillage implement 10, and each sweep assembly 12 is configured to engage the soil and to break up the soil for subsequent planting or seeding operations. The lateral spacing between the sweep assemblies 12 may be selected to enable the agricultural tillage implement 10 to effectively break up the soil along the lateral extent of the agricultural tillage implement 10 (e.g., the extent of the agricultural tillage implement 10 with respect to the lateral axis 22).

The agricultural tillage implement 10 also includes a hitch assembly 24 coupled to the frame 14. The hitch assembly 24 is configured to coupled to a corresponding hitch assembly of a work vehicle (e.g., tractor, etc.), thereby enabling the work vehicle to tow the agricultural tillage implement 10 through a field along a direction of travel 26. Furthermore, the agricultural tillage implement 10 includes wheel assemblies 28 coupled to the frame 14. The wheel assemblies 28 are configured to support the frame 14 during tillage operations and during transport of the agricultural tillage implement 10. In addition, each wheel assembly may include an actuator configured to control a vertical position of wheel(s) of the wheel assembly relative to the frame. Accordingly, the actuators of the wheel assemblies may control a height of the frame above a surface of the soil, thereby controlling the penetration depth of the sweep assemblies into the soil.

Each sweep assembly 12 is coupled to a toolbar 16 via a shank. For example, each shank may be pivotally coupled to the toolbar, and a biasing element (e.g., spring, pneumatic cylinder, hydraulic cylinder, etc.) may urge the shank to drive the sweep assembly 12 into the soil. In response to contact between the sweep assembly and an obstacle within the soil (e.g., rock, etc.), the shank may pivot to enable the sweep assembly to disengage the soil. Once the sweep assembly passes the obstacle, the biasing element may drive the shank to move the sweep assembly back into engagement with the soil.

As discussed in detail below, in certain embodiments, at least one sweep assembly 12 includes an adapter configured to couple to the respective shank. The adapter has a left angular protrusion and a right angular protrusion. Furthermore, the sweep assembly 12 includes a sweep having a blade and a neck extending from the blade. The blade is configured to break up the soil, and the neck has a cavity configured to receive the adapter. The cavity is formed in part by a forward left contact surface, a forward right contact surface, a rearward left contact surface, and a rearward right contact surface, and the neck slopes laterally inwardly along a first direction extending from a top opening of the neck toward the blade. In addition, a left contact surface angle between the forward left contact surface and the rearward left contact surface is less than or equal to 60 degrees, and the forward left contact surface and the rearward left contact surface are configured to engage the left angular protrusion of the adapter. Furthermore, a right contact surface angle between the forward right contact surface and the rearward right contact surface is less than or equal to 60 degrees, and the forward right contact surface and the rearward right contact surface are configured to engage the right angular protrusion of the adapter.

Because the left contact surfaces are configured to capture the left angular protrusion of the adapter and the right contact surfaces are configured to capture the right angular protrusion of the adapter, the friction force between the adapter and the neck of the sweep may be enhanced (e.g., as compared to a configuration in which the friction force is established by contact between lateral sides of the neck and the adapter). Furthermore, the inward slope of the neck along the first direction matches an inward slope of the adapter along the first direction. Accordingly, the left contact surfaces may engage the left angular protrusion of the adapter and the right contact surfaces may engage the right angular protrusion of the adapter along an entire extent of the angular protrusions along the first direction. As a result, the friction force between the adapter and the neck of the sweep may be enhanced (e.g., as compared to a configuration in which the adapter and the neck have non-sloped contact surfaces along the first direction). As a result of the enhanced friction force, the coupling between the sweep and the shank may be enhanced (e.g., which may reduce the possibility of the sweep disengaging the shank). In the illustrated embodiment, the agricultural tillage implement 10 is a field cultivator. However, in other embodiments, the sweep assemblies 12 disclosed herein may be used on any other suitable type of tillage implement.

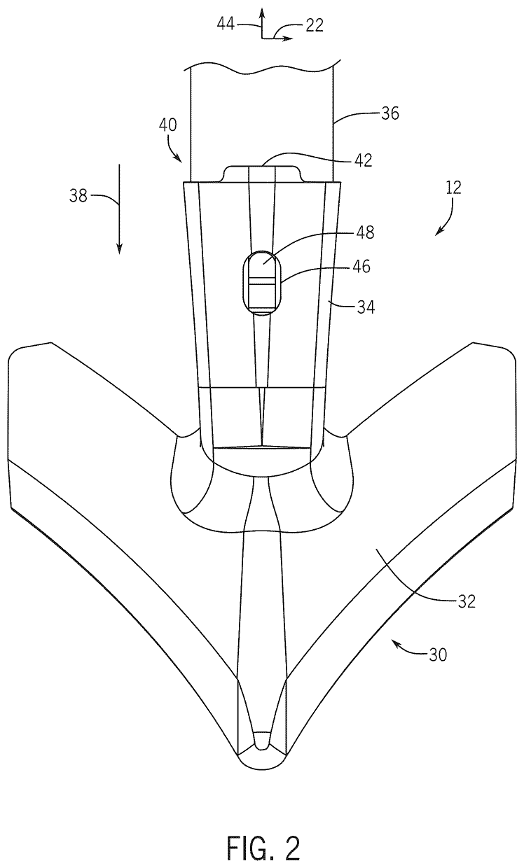

FIG. 2 is a front perspective view of an embodiment of a sweep assembly 12 that may be employed within the agricultural tillage implement of FIG. 1. In the illustrated embodiment, the sweep assembly 12 includes a sweep 30 having a blade 32 and a neck 34. The blade 32 is configured to break up the soil, and the neck 34 has a cavity configured to receive an adapter. As discussed in detail below, the adapter is configured to couple to a respective shank 36 by a fastener connection. In addition, as previously discussed, the shank 36 is coupled (e.g., pivotally coupled) to a toolbar of the agricultural tillage implement. Furthermore, in the illustrated embodiment, the neck 34 slopes laterally inwardly along a first direction 38 extending from a top opening 40 of the neck 34 toward the blade 32. Accordingly, a width of the neck 34 (e.g., extent of the neck 34 along the lateral axis 22) at the blade 32 is less than a width of the neck 34 (e.g., extent of the neck 34 along the lateral axis 22) at the top opening 40. As a result, soil flow around the neck at the blade 32 may be enhanced, thereby reducing the draft load on the work vehicle. Furthermore, the blade 32 may have any suitable shape and/or configuration.

In the illustrated embodiment, the neck 34 includes a protrusion 42 extending upwardly (e.g., with respect to a vertical direction 44) beyond the top opening 40 of the neck 34. As discussed in detail below, the protrusion 42 is configured to engage a hook of a tool to facilitate removal of the sweep 30 from the adapter. Furthermore, in the illustrated embodiment, the neck 34 has a detent opening 46 configured to receive a detent 48 coupled to the adapter. As discussed in detail below, the detent 48 is configured to block movement of the sweep 30 in the first direction 38 relative to the adapter. While the neck 34 includes the protrusion 42 in the illustrated embodiment, in other embodiments, the protrusion may be omitted.

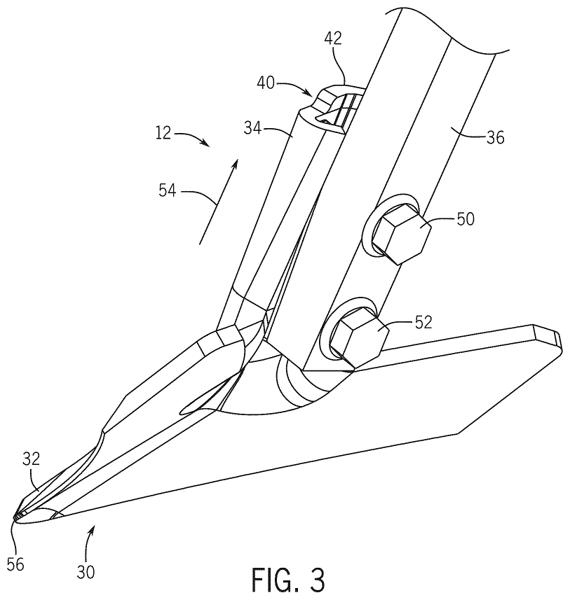

FIG. 3 is a rear perspective view of the sweep assembly 12 of FIG. 2. In the illustrated embodiment, the adapter of the sweep assembly 12 is coupled to the shank 36 by a fastener connection. As discussed in detail below, the adapter includes a first threaded recess configured to receive the threaded shaft of a first fastener 50, and the adapter includes a second threaded recess configured to receive the threaded shaft of a second fastener 52. The threaded shaft of each fastener is configured to extend through a respective opening in the shank 36, and the head of each fastener is configured to engage the shank. Accordingly, to couple the adapter to the shank 36, the threaded shaft of each fastener may be disposed through the respective opening in the shank 36, the threaded shaft of each fastener may be engaged with the respective threaded recess of the adapter, and the fasteners may be rotated to secure the adapter to the shank 36. While the fastener connection includes two fasteners in the illustrated embodiment, in other embodiments, the fastener connection may include more or fewer fasteners (e.g., 1, 3, 4, or more). Furthermore, while the adapter is coupled to the shank by a fastener connection in the illustrated embodiment, in other embodiments, the adapter may be coupled to the shank by another suitable type of connection (e.g., alone or in combination with the fastener connection), such as an adhesive connection, a press-fit connection, a welded connection, other suitable type(s) of connection(s), or a combination thereof).

To couple the sweep 30 to the adapter, the top opening 40 of the neck 34 is aligned with the adapter. A force is then applied to the sweep 30 to drive the sweep 30 along a second direction 54, such that the adapter is disposed within the cavity of the neck 34. For example, as discussed in detail below, a tip interface of the tool may be engaged with a tip 56 of the sweep 30. An operator may then hit the tip interface of the tool with a hammer, and the tip interface may transfer energy from each hammer impact to the sweep 30, thereby driving the sweep into engagement with the adapter.

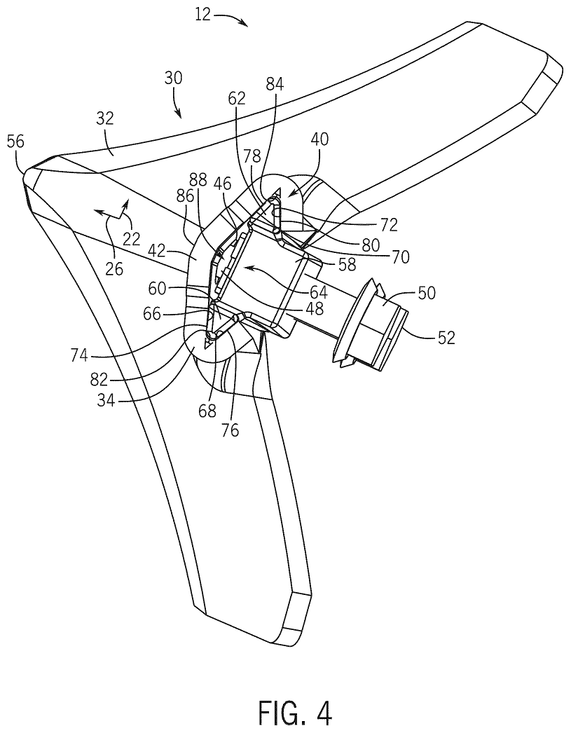

FIG. 4 is a top view of the sweep assembly 12 of FIG. 2. In the illustrated embodiment, the adapter 58 has a left angular protrusion 60 and a right angular protrusion 62. In addition, the cavity 64 of the neck 34, which extends to the top opening 40, is formed in part by a forward left contact surface 66, a rearward left contact surface 68, a forward right contact surface 70, and a rearward right contact surface 72. The forward left contact surface 66 and the rearward left contact surface 68 of the neck 34 are configured to engage the left angular protrusion 60 of the adapter 58. As illustrated, the forward left contact surface 66 of the neck 34 contacts a corresponding forward left contact surface 74 of the left angular protrusion 60, and the rearward left contact surface 68 of the neck 34 contacts a corresponding rearward left contact surface 76 of the left angular protrusion 60. Furthermore, the forward right contact surface 70 and the rearward right contact surface 72 of the neck 34 are configured to engage the right angular protrusion 62 of the adapter 58. As illustrated, the forward right contact surface 70 of the neck 34 contacts a corresponding forward right contact surface 78 of the right angular protrusion 62, and the rearward right contact surface 72 of the neck 34 contacts a corresponding rearward right contact surface 80 of the right angular protrusion 62.

In the illustrated embodiment, a left contact surface angle 82 between the forward left contact surface 66 and the rearward left contact surface 68 of the neck 34 is less than or equal to 60 degrees. In addition, a right contact surface angle 84 between the forward right contact surface 70 and the rearward right contact surface 72 of the neck 34 is less than or equal to 60 degrees. Because the left and right contact surface angles are less than or equal to 60 degrees, the left contact surfaces are configured to capture the left angular protrusion 60 of the adapter 58, and the right contact surfaces are configured to capture the right angular protrusion 62 of the adapter 58. As a result, the friction force between the adapter 58 and the neck 34 of the sweep 30 may be enhanced (e.g., as compared to a configuration in which the friction force is established by contact between lateral sides of the neck and the adapter). Accordingly, the coupling between the sweep 30 and the shank may be enhanced (e.g., which may reduce the possibility of the sweep 30 disengaging the shank). In the illustrated embodiment, the left contact surface angle 82 is equal to the right contact surface angle 84. However, in other embodiments, the left contact surface angle may be greater or less than the right contact surface angle. Furthermore, in certain embodiments, the left contact surface angle may be less than or equal to 55 degrees, less than or equal to 50 degrees, less than or equal to 45 degrees, less than or equal to 40 degrees, less than or equal to 35 degrees, or less than or equal to 30 degrees. For example, in certain embodiments, the left contact surface angle may be between 25 and 60 degrees, between 30 and 55 degrees, between 35 and 50 degrees, or between 40 and 50 degrees. In addition, in certain embodiments, the right contact surface angle may be less than or equal to 55 degrees, less than or equal to 50 degrees, less than or equal to 45 degrees, less than or equal to 40 degrees, less than or equal to 35 degrees, or less than or equal to 30 degrees. For example, in certain embodiments, the right contact surface angle may be between 25 and 60 degrees, between 30 and 55 degrees, between 35 and 50 degrees, or between 40 and 50 degrees.

In certain embodiments, the adapter is formed from metal (e.g., steel, etc.), and the sweep is formed from metal (e.g., steel, etc.). For example, the adapter 58 may be formed from a single piece of metal (e.g., via a machining process, via an additive manufacturing process, via a casting process, via a forging process, or a combination thereof). In certain embodiments, the angular protrusions are precisely formed (e.g., by a machining process, by an additive manufacturing process, etc.) to establish effective contact with the corresponding contact surfaces of the neck. Furthermore, the sweep may be formed from a single piece of metal (e.g., via a stamping process, via a machining process, via an additive manufacturing process, via a casting process, via a forging process, or a combination thereof). In certain embodiments, the neck of the sweep may be formed by wrapping a hot sheet of metal around a form and compressing the hot sheet of metal against the form, thereby precisely forming the contact surfaces of the neck to establish effective contact with the corresponding angular protrusions of the adapter.

In the illustrated embodiment, the neck 34 forms a crown 86 between the forward left contact surface 66 and the forward right contact surface 70. As illustrated, the crown 86 is positioned at the lateral center of the neck 34 (e.g., the center of the neck with respect to the lateral axis 22). In addition, the crown 86 extends along the first direction. The crown 86 is configured to direct soil around the neck 34, thereby reducing the draft load on the work vehicle. In addition, in the illustrated embodiment, the crown 86 is configured to form a gap 88 between the neck 34 of the sweep 30 and the adapter 58. While the crown 86 is configured to form the gap 88 between the neck 34 and the adapter 58 in the illustrated embodiment, in other embodiments, the crown may not form the gap. Furthermore, while the neck 34 includes the crown 86 in the illustrated embodiment, in other embodiments, the crown may be omitted (e.g., a front surface of the neck may have another suitable shape).

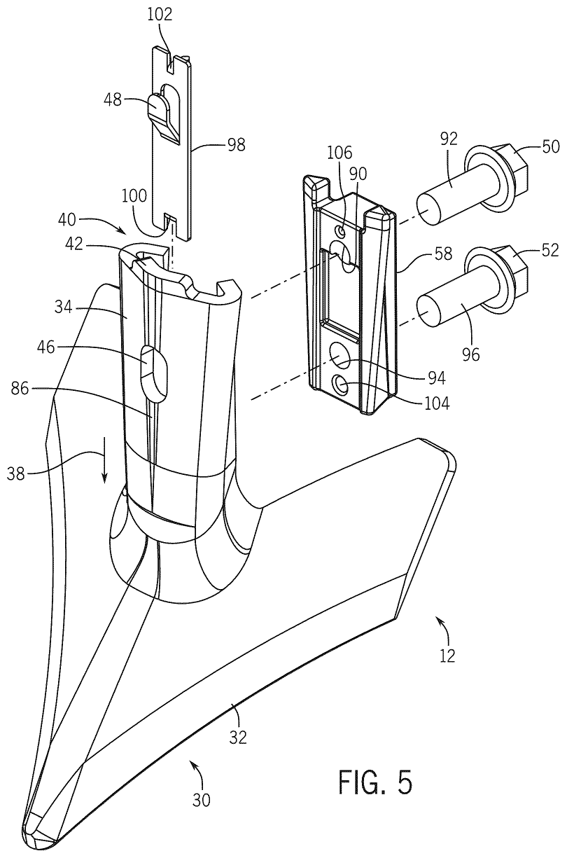

FIG. 5 is an exploded view of the sweep assembly 12 of FIG. 2. As previously discussed, the adapter 58 includes a first threaded recess 90 configured to receive the threaded shaft 92 of the first fastener 50, and the adapter 58 includes a second threaded recess 94 configured to receive the threaded shaft 96 of the second fastener 52. The threaded shaft of each fastener is configured to extend through a respective opening in the shank, and the head of each fastener is configured to engage the shank. Accordingly, to couple the adapter 58 to the shank, the threaded shaft of each fastener may be disposed through the respective opening in the shank, the threaded shaft of each fastener may be engaged with the respective threaded recess of the adapter 58, and the fasteners may be rotated to secure the adapter 58 to the shank. Because the adapter 58 includes threaded recesses, nuts (e.g., which may be employed in certain configurations to couple the fasteners to the adapter and the shank) may be obviated, thereby reducing the number of parts of the sweep assembly.

As previously discussed, the neck 34 forms the crown 86 between the forward left contact surface and the forward right contact surface. As illustrated, the crown 86 is positioned at the lateral center of the neck 34. However, in other embodiments, the crown may be laterally offset from the lateral center of the neck. For example, the crown may be closer to the forward left contact surface, or the crown may be closer to the forward right contact surface. Furthermore, as illustrated, the crown 86 extends along the first direction 38, and the crown 86 tapers inwardly along the first direction 38. In addition, a gap in the crown 86 is formed by the detent opening 46. While the crown 86 tapers inwardly along the first direction 38 in the illustrated embodiment, in other embodiments, the crown may be tapered outwardly along the first direction, or the crown may not be tapered. Furthermore, the crown 86 may have any suitable extent along the first direction 38.

In the illustrated embodiment, the sweep assembly 12 includes a retainer clip 98 configured to couple to the adapter 58. The retainer clip 98 includes the detent 48, which is configured to engage the detent opening 46 in the neck 34 of the sweep 30. As discussed in detail below, contact between the detent 48 and the neck 34 of the sweep 30 while the detent is engaged with the detent opening 46 blocks movement of the sweep 30 in the first direction 38 relative to the adapter 58. As a result, the possibility of the sweep 30 uncoupling from the shank during operation of the agricultural tillage implement may be substantially reduced or eliminated.

In the illustrated embodiment, the retainer clip 98 includes a first tab 100 and a second tab 102. In addition, the adapter 58 includes a first recess 104 (e.g., first corresponding recess) and a second recess 106 (e.g., second corresponding recess). The first tab 100 is configured to engage the first recess 104, and the second tab 102 is configured to engage the second recess 106. In the illustrated embodiment, a width of the first tab 100 and a width of the first recess 104 are selected to establish a press-fit connection upon engagement of the first tab 100 with the first recess 104. In addition, a width of the second tab 102 and a width of the second recess 106 are selected to establish a press-fit connection upon engagement of the second tab 102 with the second recess 106. The press-fit connections between the tabs and the corresponding recesses couple the retainer clip 98 to the adapter 58, thereby enabling the adapter to be disposed within the cavity of the neck without separation of the retainer clip from the adapter. While the retainer clip 98 has two tabs and the adapter 58 has two recesses in the illustrated embodiment, in other embodiments, the retainer clip may include more or fewer tabs (e.g., 1, 3, 4, or more), and the adapter may include a corresponding number of recesses. Furthermore, while the retainer clip 98 is coupled to the adapter 58 by tab(s) and recess(es) in the illustrated embodiment, in other embodiments, the retainer clip may be coupled to the adapter by any other suitable type(s) of connection(s) (e.g., alone or in combination with the tab(s)/recess(es) connection), such as a fastener connection, a welded connection, an adhesive connection, other suitable type(s) of connection(s), or a combination thereof.

While the sweep assembly 12 includes the retainer clip 98 in the illustrated embodiment, in certain embodiments, the retainer clip 98 may be omitted. For example, in certain embodiments, the detent may be integral with the adapter. For example, the detent and the adapter may be integrally formed from a single piece of material (e.g., spring steel, etc.). Furthermore, in certain embodiments, the detent may be omitted, thereby obviating the retainer clip. In such embodiments, the detent opening may be omitted, and the sweep may be coupled to the adapter only via the friction between the angular protrusions of the adapter and the contact surfaces of the neck.

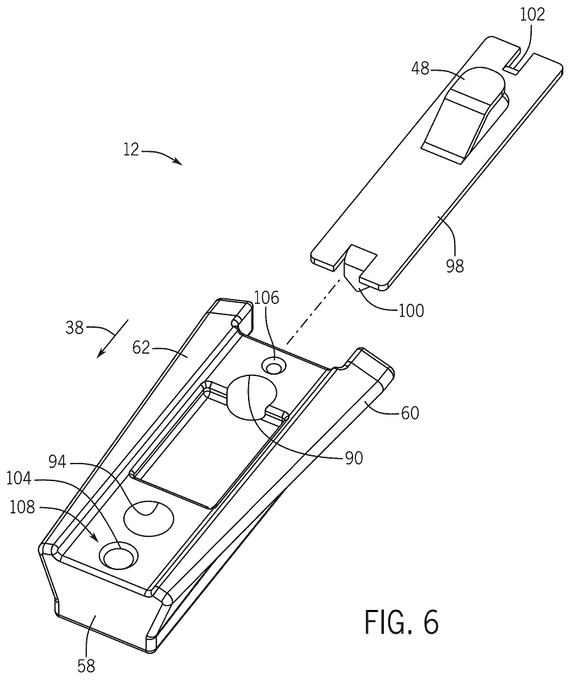

FIG. 6 is an exploded view of a portion of the sweep assembly 12 of FIG. 2. As previously discussed, the first tab 100 of the retainer clip 98 is configured to engage the first recess 104 of the adapter 58, and the second tab 102 of the retainer clip 98 is configured to engage the second recess 106 of the adapter 58, thereby coupling the retainer clip 98 to the adapter 58 via press-fit connections. In the illustrated embodiment, the first tab 100 is wider than the second tab 102, and the first recess 104 is wider than the second recess 106. In addition, the first tab 100 is wider than the second recess 106. Accordingly, the first tab 100 may not be engaged with the second recess 106. As a result, the possibility of the retainer clip being coupled to the adapter at an undesirable orientation may be substantially reduced or eliminated.

In the illustrated embodiment, the adapter 58 has an indentation 108 formed between the left angular protrusion 60 and the right angular protrusion 62. The indentation 108 is configured to receive the retainer clip 98. In certain embodiments, the depth of the indentation 108 may be equal to the thickness of the retainer clip 98. However, in other embodiments, the depth of the indentation may be greater or less than the thickness of the retainer clip. Furthermore, in certain embodiments, the indentation may be omitted.

As previously discussed, the neck of the sweep slopes inwardly along the first direction. In addition, as illustrated, the left angular protrusion 60 of the adapter 58 and the right angular protrusion 62 of the adapter 58 slope inwardly along the first direction 38. Accordingly, the left contact surfaces of the neck may engage the left angular protrusion 60 of the adapter 58 and the right contact surfaces of the neck may engage the right angular protrusion 62 of the adapter 58 along an entire extent of the angular protrusions along the first direction. As a result, the friction force between the adapter 58 and the neck of the sweep may be enhanced (e.g., as compared to a configuration in which the adapter and the neck have non-sloped contact surfaces along the first direction). As a result of the enhanced friction force, the coupling between the sweep and the shank may be enhanced (e.g., which may reduce the possibility of the sweep disengaging the shank).

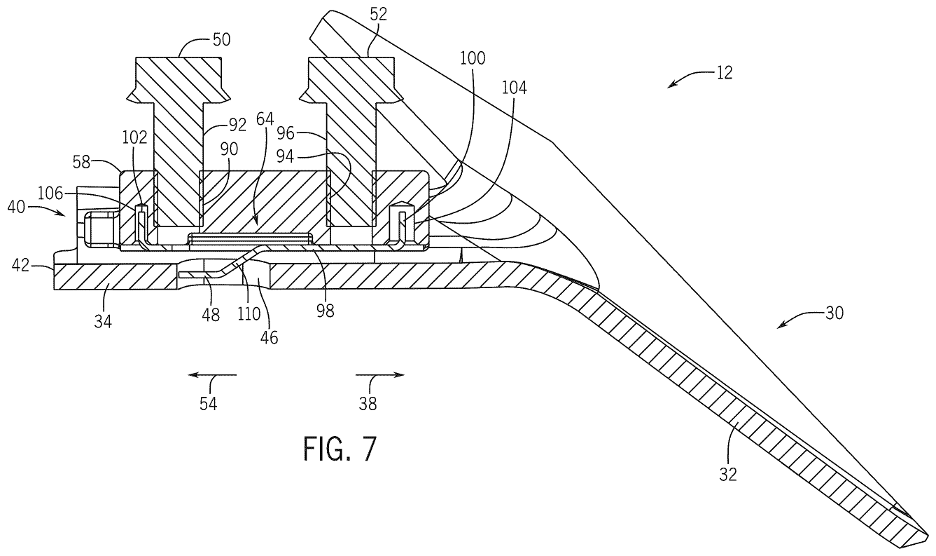

FIG. 7 is a cross-sectional view of the sweep assembly 12 of FIG. 2. As illustrated, the threaded shaft 92 of the first fastener 50 is engaged with the first threaded recess 90 of the adapter 58, and the threaded shaft 96 of the second fastener 58 is engaged with the second threaded recess 94 of the adapter 58. In addition, the first tab 100 of the retainer clip 98 is engaged with the first recess 104 of the adapter 58, and the second tab 102 of the retainer clip 98 is engaged with the second recess 106 of the adapter 58. Furthermore, the detent 48 of the retainer clip 98 is engaged with the detent opening 46. Accordingly, the adapter 58 is coupled to the shank, the retainer clip 98 is coupled to the adapter 58, and the sweep 30 is coupled to the adapter 58. As a result, the sweep 30 is coupled to the shank.

The detent 48 of the retainer clip 98 is flexible and biased toward the illustrated extended position. In certain embodiments, the retainer clip may be formed from a flexible material, such as spring steel, and the detent may be formed via a stamping process. In addition, the first tab and the second tab may be formed via a stamping process. For example, in certain embodiments, the detent and the tabs may be formed by stamping a flat sheet of metal, such as spring steel, thereby forming the retainer clip. However, in other embodiments, the retainer clip, including the detent and the tabs, may be formed by any other suitable process (e.g., alone or in combination with the stamping process), such as an additive manufacturing process, a machining process, a casting process, a forging process, other suitable process(es), or a combination thereof.

With the detent 48 in the illustrated extended position, movement of the sweep 30 in the first direction 38 relative to the adapter 58 is blocked by contact between the detent 48 and the neck 34 of the sweep 30. Furthermore, in the illustrated embodiment, the detent 48 includes a ramp 110. As previously discussed, the sweep 30 may be coupled to the adapter 58 by aligning the top opening 40 of the neck 34 with the adapter 58 and applying a force to the sweep 30 to drive the sweep 30 to move along the second direction 54. As the sweep 30 moves along the second direction 54, contact between the neck 34 and the ramp 110 of the detent 48 drives the detent to a retracted position, thereby facilitating movement of the sweep 30 in the second direction 54. Once the detent 48 reaches the detent opening 46, the detent 48 moves to the illustrated extended position. The detent 48 and the detent opening 46 are particularly located to position the sweep 30 at a target location along the shank while the detent 48 is engaged with the detent opening 46. As a result, the accuracy of the vertical position of the sweep 30 relative to the frame of the agricultural tillage implement may be enhanced (e.g., as compared to a configuration in which the sweep is coupled to the adapter by friction alone).

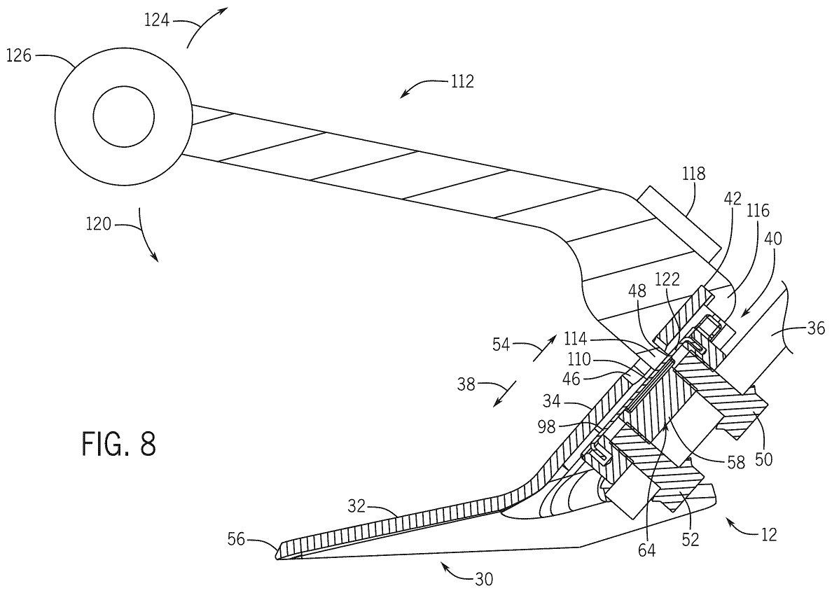

FIG. 8 is a side view of an embodiment of a tool 112 that may be employed within the sweep assembly 12 of FIG. 2. The tool 112 is configured to facilitate removal of the sweep 30 from the adapter 58. As previously discussed, the neck 34 of the sweep 30 has a detent opening 46, and the detent 48 of the retainer clip 98 is configured to engage the detent opening 46 to block movement of the sweep 30 in the first direction 38 relative to the adapter 58. In the illustrated embodiment, the tool 112 includes a protrusion 114 configured to extend through the detent opening 46 and engage the detent 48 to facilitate removal of the sweep 30 from the adapter 58. As illustrated, engagement of the protrusion 114 of the tool 112 with the detent 48 drives the detent 48 to the retracted position, thereby enabling movement of the sweep 30 in the first direction 38 relative to the adapter 58.

As previously discussed, the protrusion 42 of the neck 34 extends upwardly beyond the top opening 40 of the neck 34. In the illustrated embodiment, the tool 112 includes a hook 116 configured to engage the protrusion 42 of the neck 34 to facilitate rotation of the tool 112, which moves the protrusion 114 of the tool 112 into engagement with the detent 48. In addition, engagement of the hook 116 of the tool 112 with the protrusion 42 of the neck 34 enables a force to be applied to the tool 112 to drive the sweep 30 to move in the first direction 38 relative to the adapter 58. In the illustrated embodiment, the tool 112 includes a pad 118 configured to receive an impact from a hammer to drive the tool 112 to move the sweep 30 in the first direction 38. While the tool 112 includes the pad 118 in the illustrated embodiment, in other embodiments, the pad may be omitted.

By way of example, to remove the sweep 30 from the adapter 58, the hook 116 of the tool 112 is engaged with the protrusion 42 of the neck 34. The tool 112 is then rotated in a first rotational direction 120 to move the protrusion 114 of the tool 112 through the detent opening 48 and into engagement with the detent 48, thereby driving the detent 48 to the retracted position. A hammer may then be used to impact the pad 118 of the tool 112, thereby driving the sweep 30 to move in the first direction 38 relative to the adapter 58. Movement of the sweep 30 a short distance in the first direction 38 causes an end 122 of the detent 48 to be positioned outside of the detent opening 46. Accordingly, the detent 48 does not block movement of the sweep 30 in the first direction 38 (e.g., even when the detent transitions to the extended position or to a partially extended position). Furthermore, due to the inward slope of the neck 34 and the inward slope of the angular protrusions of the adapter 58, movement of the sweep through the short distance in the first direction 38 relative to the adapter 58 substantially reduces the friction force between the neck 34 of the sweep 30 and the adapter 58. As a result, after the sweep 30 moves the short distance in the first direction 38 relative to the adapter 58, the sweep 30 may be fully disengaged from the adapter 58 via application of force in the first direction 38 (e.g., a manually applied force, the force of hammer impact(s) to the sweep, etc.). Furthermore, after the sweep 30 moves the short distance in the first direction 38 relative to the adapter 58, the tool 112 may be disengaged from the sweep 30 via rotation in a second rotational direction 124. The hook 116 of the tool 112 and the adapter 58 may be configured to enable movement of the sweep 30 through the short distance without contact between the tool 112 and the adapter 58 (e.g., the adapter may include a recess configured to receive an end of the hook as the sweep moves through the short distance).

Furthermore, in the illustrated embodiment, the tool 112 includes a tip interface 126 configured to engage the tip 56 of the sweep 30. The tip interface 126 is configured to transfer energy from a hammer impact to the sweep 30 to drive the sweep 30 into engagement with the adapter 58. For example, to couple the sweep 30 to the adapter 58, the top opening 40 of the neck 34 is aligned with the adapter 58. Next, the tip interface 126 is engaged with the tip 56 of the sweep 30, and hammer impacts to the tip interface 126 drive the sweep 30 to move along the second direction 54. As the sweep 30 moves along the second direction 54, contact between the neck 34 and the ramp 110 of the detent 48 drives the detent to a retracted position, thereby facilitating movement of the sweep 30 in the second direction 54. Once the detent 48 reaches the detent opening 46, the detent 48 moves to the extended position, thereby blocking movement of the sweep 30 in the first direction 38.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A sweep assembly for an agricultural tillage implement, comprising:
a sweep having a blade and a neck extending from the blade, wherein the neck has a cavity configured to receive an adapter, the cavity is formed in part by a forward left contact surface, a forward right contact surface, a rearward left contact surface, and a rearward right contact surface, and the neck slopes laterally inwardly along a first direction extending from a top opening of the neck toward the blade;
wherein a left contact surface angle between the forward left contact surface and the rearward left contact surface is less than or equal to 60 degrees, and the forward left contact surface and the rearward left contact surface are configured to engage a left angular protrusion of the adapter; and
wherein a right contact surface angle between the forward right contact surface and the rearward right contact surface is less than or equal to 60 degrees, and the forward right contact surface and the rearward right contact surface are configured to engage a right angular protrusion of the adapter.

2. The sweep assembly of claim 1, wherein the neck forms a crown between the forward left contact surface and the forward right contact surface, and the crown extends along the first direction.

3. The sweep assembly of claim 2, wherein the crown is configured to form a gap between the sweep and the adapter.

4. The sweep assembly of claim 1, wherein the neck has a detent opening configured to receive a detent coupled to the adapter to block movement of the sweep in the first direction relative to the adapter.

5. The sweep assembly of claim 1, wherein the neck comprises a protrusion extending upwardly beyond the top opening of the neck.

6. A sweep assembly for an agricultural tillage implement, comprising:
an adapter configured to couple to a shank of the agricultural tillage implement, wherein the adapter has a left angular protrusion and a right angular protrusion; and
a sweep having a blade and a neck extending from the blade, wherein the neck has a cavity configured to receive the adapter, the cavity is formed in part by a forward left contact surface, a forward right contact surface, a rearward left contact surface, and a rearward right contact surface, and the neck slopes laterally inwardly along a first direction extending from a top opening of the neck toward the blade;
wherein a left contact surface angle between the forward left contact surface and the rearward left contact surface is less than or equal to 60 degrees, and the forward left contact surface and the rearward left contact surface are configured to engage the left angular protrusion of the adapter; and
wherein a right contact surface angle between the forward right contact surface and the rearward right contact surface is less than or equal to 60 degrees, and the forward right contact surface and the rearward right contact surface are configured to engage the right angular protrusion of the adapter.

7. The sweep assembly of claim 6, wherein the adapter comprises a threaded recess configured to receive a fastener to couple the adapter to the shank.

8. The sweep assembly of claim 6, comprising a retainer clip configured to couple to the adapter, wherein the retainer clip comprises a detent, the neck of the sweep has a detent opening, and the detent is configured to engage the detent opening to block movement of the sweep in the first direction relative to the adapter.

9. The sweep assembly of claim 8, wherein the retainer clip comprises at least one tab, the adapter has at least one corresponding recess, and the at least one tab is configured to engage the at least one corresponding recess to establish a press-fit connection to couple the retainer clip to the adapter.

10. The sweep assembly of claim 9, wherein the at least one tab comprises two tabs, and the at least one corresponding recess comprises two corresponding recesses.

11. The sweep assembly of claim 10, wherein a first tab of the two tabs is wider than a second tab of the two tabs, a first corresponding recess of the two corresponding recesses is wider than a second corresponding recess of the two corresponding recesses, the first tab is configured to engage the first corresponding recess, the second tab is configured to engage the second corresponding recess, and the first tab is wider than the second corresponding recess.

12. The sweep assembly of claim 6, wherein the neck forms a crown between the forward left contact surface and the forward right contact surface, and the crown extends along the first direction.

13. The sweep assembly of claim 12, wherein the crown is configured to form a gap between the sweep and the adapter.

14. The sweep assembly of claim 6, wherein the neck comprises a protrusion extending upwardly beyond the top opening of the neck.

15. A sweep assembly for an agricultural tillage implement, comprising:
an adapter configured to couple to a shank of the agricultural tillage implement, wherein the adapter has a left angular protrusion and a right angular protrusion;
a retainer clip configured to couple to the adapter, wherein the retainer clip comprises a detent;
a sweep having a blade and a neck extending from the blade, wherein the neck has a cavity configured to receive the adapter, the cavity is formed in part by a forward left contact surface, a forward right contact surface, a rearward left contact surface, and a rearward right contact surface, and the neck slopes laterally inwardly along a first direction extending from a top opening of the neck toward the blade; and
a tool configured to facilitate removal of the sweep from the adapter;
wherein a left contact surface angle between the forward left contact surface and the rearward left contact surface is less than or equal to 60 degrees, and the forward left contact surface and the rearward left contact surface are configured to engage the left angular protrusion of the adapter;
wherein a right contact surface angle between the forward right contact surface and the rearward right contact surface is less than or equal to 60 degrees, and the forward right contact surface and the rearward right contact surface are configured to engage the right angular protrusion of the adapter; and
wherein the neck of the sweep has a detent opening, the detent of the retainer clip is configured to engage the detent opening to block movement of the sweep in the first direction relative to the adapter; and the tool comprises a protrusion configured to extend through the detent opening and engage the detent to facilitate removal of the sweep from the adapter.

16. The sweep assembly of claim 15, wherein the neck comprises a protrusion extending upwardly beyond the top opening of the neck, and the tool comprises a hook configured to engage the protrusion of the neck to facilitate rotation of the tool relative to the neck.

17. The sweep assembly of claim 15, wherein the tool comprises a tip interface configured to engage a tip of the sweep, and the tip interface is configured to transfer energy from a hammer impact to the sweep.

18. The sweep assembly of claim 15, wherein the adapter comprises a threaded recess configured to receive a fastener to couple the adapter to the shank.

19. The sweep assembly of claim 15, wherein the retainer clip comprises at least one tab, the adapter has at least one corresponding recess, and the at least one tab is configured to engage the at least one corresponding recess to establish a press-fit connection to couple the retainer clip to the adapter.

20. The sweep assembly of claim 19, wherein the at least one tab comprises two tabs, the at least one corresponding recess comprises two corresponding recesses, a first tab of the two tabs is wider than a second tab of the two tabs, a first corresponding recess of the two corresponding recesses is wider than a second corresponding recess of the two corresponding recesses, the first tab is configured to engage the first corresponding recess, the second tab is configured to engage the second corresponding recess, and the first tab is wider than the second corresponding recess.
